(19) United States
(12) Patent Application Publication
(10) Pub. No.: US 2014/0130215 A1
(43) Pub. Date: May 8, 2014

(54) Indented Mold Structures For Diamond Deposited Probes

(71) Applicant: RAVE, LLC, Delray Beach, FL (US)

(72) Inventors: David Brinkley, Pikesville, MD (US); Roy L. White, Wellington, FL (US)

(73) Assignee: RAVE, LLC, Delray Beach, FL (US)

(21) Appl. No.: 13/671,133

(22) Filed: Nov. 7, 2012

(51) Int. Cl. G01Q 70/16; G01Q 70/08

(52) U.S. Cl. CPC G01Q 70/16; G01Q 70/08
USPC 850/56; 427/133; 216/52

(57) ABSTRACT

The present invention discloses a method of fabricating a scanning probe microscopy probe including positioning a pattern probe over a mold substrate; indenting the pattern probe into the mold substrate material to form a mold pit; depositing a film onto the mold substrate including the mold pit; removing a portion of the deposited film to form a probe, and releasing the probe from the mold substrate material.

### FIELD OF THE INVENTION

The present invention relates generally to nanostructures and more specifically to methods of fabricating a probe for use in applications such as scanning probe microscopy, material hardness testing and nanomachining.

### BACKGROUND OF THE INVENTION

Fabrication of high aspect ratio scanning probe microscopy (SPM), where SPM encompasses the following: Atomic Force Microscopy (AFM), Scanning Tunneling Microscopy (STM), Lateral Force Microscopy (LFM), Magnetic Force Microscopy (MFM) and Near-field Scanning Optical Microscopy (NSOM) and many others more obscure types not listed, probes via deposition processes requires a high aspect molded structure, from this point forward referred to as the mold or mold pit, to be filled by the material being deposited. The mold must meet two distinct criteria: 1) the mold must have a small probe radius or a sharp point at its apex and 2) the mold must have an aspect ratio that meets the need of the application.

For lower aspect ratio probes, both of these criteria can be met by making the mold through a silicon anisotropic etching process. This process can give probe radii as small as 10 nm but limits probe aspect ratios to <0.71. FIGS. 1A and 1B illustrate an etch pit 150 formed using the silicon anisotropic etching process and the resulting tip 212. The aspect ratio is defined as Length/Width or where L refers to length and W refers to width as shown in FIGS. 1A and 1B. The probe aspect ratios are limited in part due to anisotropic wet etchants like potassium hydroxide (KOH) displaying an etch rate selectivity higher in <100> crystal direction than in the <110> direction. Thus, etching a <100> silicon surface through a square hole in a masking material creates a pit with flat sloping <111>-oriented sidewalls at angle α equal to 54.7° that self-terminates forming a sharp apex. A rectangular hole in the masking layer will create a wedge or knife edge structure in the silicon after etching. There are numerous ways known in the art to form an etched 4-sided pyramidal shaped mold in silicon that can be filled with a deposition material.

Deposited square pyramidal probes form in this manner can be modified to overcome the aspect ratio limitation in a number of ways. A technique such as Focus Ion Beam (FIB) etching can be used to remove diamond material at and around the probe apex. This technique can be used to shape the probe creating a higher aspect ratio; however, this has some disadvantages. First, the FIB utilizes a Gaussian shaped beam. The tails of this beam round the sharp apex structure formed by the etched mold. Thus, the probe gains aspect ratio at the expense of probe radius. Second, the FIB uses a gallium atom source, in which the gallium atoms strike the probe surface with significant force and are implanted into the deposited material. This ion implantation creates defects in the deposited material that can reduce the Young's modulus and weakening the material. This is especially true if the deposited material is crystalline in nature. Finally, the modifications are done on a probe by probe basis, which means that each probe is slightly different due to small changes in orientation. Furthermore, the modification process is time consuming and often cost prohibitive especially if large volumes of probes are required for a particular application.

There are other ways to modify the aspect ratio of the probe formed by the silicon molding process. For example, an electron beam (EB) etching process could be used instead of a FIB. Although using EB alleviates the ion implantation issue, it does not address the probe apex dulling issue. In addition, the process would be very slow without a chemically assisted etching process which can be difficult to apply to some crystalline materials like diamond and boron nitride. Again, this technique must be done on probe by probe basis leading to the same disadvantages associated with the modification of probes using FIB.

Laser ablation is another technique that could be used, however, minimum laser beam diameters are large compared to the probe apex and the shape of the ablation beam still has a Gaussian profile such that dulling of the probe apex will occur. In addition, the way in which material is ejected in the ablation process will lead to unwanted damage in areas not exposed to the laser beam.

Another way of addressing the aspect ratio limit is to change the shape of the mold being filled with the diamond material. The same techniques reviewed above could be used for this purpose. In the case of the FIB, the ion implantation would no longer be an issue because the mold structure is sacrificial in nature and is removed through an etch process. However, the Gaussian shaped beam utilized with all top down material removal techniques (FIB, EB and laser ablation) make it very difficult, if not impossible, to achieve probe radii on the order of 10 nm.

All of the shaping techniques discuss above not only have technical hurdles but because they are done on an individual probe basis, they are costly to produce and less consistent than a wafer scale process. All of the methods discussed above for fabricating a high aspect ratio probe use a multi-step process where individual probes are molded and then modified post molding to achieve the desired aspect ratio. It would be more desirable to fabricate a high aspect ratio probe using a method that did not require any post processing of individual fabricated probes.

The present invention discloses an alternative method to change the shape of the mold structure that does not involve FIB, EB or laser ablation of individual probes. The present invention also requires no post processing of the probe to achieve the desired aspect ratio once the probe material is deposited into the mold. This novel method can be used in many applications and is particularly useful for a direct wafer scale fabrication process.

### SUMMARY OF THE INVENTION

The disadvantages of the prior art are overcome by the present invention, which in one aspect, is a novel method of fabricating a SPM probe. The method of fabricating a SPM probe including positioning a pattern probe over a mold substrate, indenting the pattern probe into the mold substrate material to form a mold pit, depositing a film onto the mold substrate including the mold pit, removing a portion of the deposited film to form a probe, and releasing the probe from the mold substrate material.

### BRIEF DESCRIPTION OF THE DRAWINGS

These features and aspects of the invention as well as its advantages are understood by referring to the following description, appended claims and accompanying drawings, in which:

FIG. 1A is schematic cross-sectional view of a prior art mold formed by a silicon anisotropic etching.

FIG. 1B is a schematic cross-sectional view of the maximum aspect ratio that can be achieved for a probe and a mold substrate by using the prior art mold shown in FIG. 1A.

FIG. 2A is a schematic side view of the mold substrate material and pattern probe prior to the indenting step. The arrow F illustrates the direction of applied force that the pattern probe uses on the mold substrate material.

FIG. 2B is a schematic cross-sectional view of the pattern probe indenting the mold substrate material.

FIG. 2C is a schematic cross-sectional view of the pattern probe being retracted from the mold substrate material and leaving a mold pit formed in the shape of the pattern probe. The arrow F illustrates the direction of applied force that is exerted on the pattern probe to retract it from the mold substrate material.

FIG. 2D is a schematic cross-sectional view of the film deposited on mold substrate material such that the mold pit is filled with the deposited film.

FIG. 2E is a schematic cross-sectional view of the molded substrate material and deposited film after a portion of the deposited film has been removed to define the probe.

FIG. 2F is a schematic top view of the probe shown in FIG. 2E not drawn to scale.

FIG. 2G is a schematic top view of the probe shown in FIGS. 2E drawn to scale.

FIG. 2H is a schematic side view of the probe released from the mold substrate material.

FIG. 2I is a schematic top view of the probe shown in FIG. 2H not drawn to scale.

FIG. 2J is a schematic isometric view of the probe shown in FIG. 2H drawn to scale.

FIG. 3A is a schematic top view of pyramidal etch pit in a mold substrate material that is Si<100> wafer.

FIG. 3B is a schematic cross-sectional view of pyramidal etch pit in a mold substrate material that is Si<100> wafer.

FIG. 3C is a schematic cross-sectional view of a pattern probe indenting the nadir of the etch pit to form a mold pit.

FIG. 3D is a schematic cross-sectional view of a mold pit formed in the nadir of the etch pit shown in the mold substrate material.

FIG. 3E is a schematic cross-sectional view of the film deposited on the mold substrate material such that the etch pit and mold pit are filled with the deposited film.

FIG. 3F is a schematic cross-sectional view of the mold substrate material and deposited film after a portion of the deposited film has been removed to define the probe.

FIG. 3G is a schematic top view of the probe shown in FIG. 3F not drawn to scale.

FIG. 3H is a schematic top view of the probe shown in FIG. 3F drawn to scale.

FIG. 3I is a schematic side view of the probe released from the mold substrate material.

FIG. 3J is a schematic top view of the probe shown in FIG. 3I not drawn to scale.

FIG. 3K is a schematic isometric view of the probe shown in FIG. 3I drawn to scale.

FIG. 4A is a schematic top view of a pyramidal etch pit in a mold substrate material that is Si<100> wafer where the etching was halted prior to self-termination.

FIG. 4B is a schematic cross-sectional view of a pyramidal etch pit in a mold substrate material that is Si<100> wafer where the etching was halted prior to self-termination.

FIG. 4C is a schematic cross-sectional view of a pattern probe indenting the flat bottom portion of the etch pit to form a mold pit.

FIG. 4D is a schematic cross-sectional view of a mold pit formed in the flat bottom portion of the etch pit shown in the mold substrate material.

FIG. 4E is a schematic cross-sectional view of the film deposited on the mold substrate material such that the etch pit and the mold pit are filled with the deposited film.

FIG. 5A is a schematic cross-sectional view of titling the pattern probe with respect to the mold substrate to create an angled mold pit according to one embodiment of the present invention.

FIG. 5B is a schematic cross-sectional view of tilting the mold substrate material and the pattern probe to create an angled mold pit according to one embodiment of the present invention.

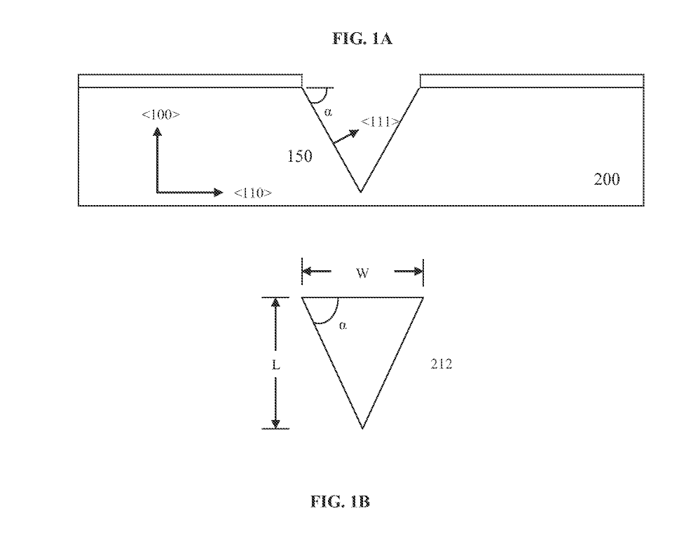

### DETAILED DESCRIPTION

The present invention discloses a novel method of fabricating a SPM probe. The SPM probe 250 includes a planar body 230, a cantilever 225 extending from an edge of the body 230, and a tip 212 depending from an end of the cantilever 225, having a length and a width.

The method of fabricating the SPM probe 250 comprises the steps of: (a) positioning a pattern probe 205 over a mold substrate material 200; (b) indenting the pattern probe 205 into the mold substrate material 200 such that a mold pit 210 is formed in the shape of the pattern probe 205; (c) depositing a film 215 onto the mold substrate material 200 such that the mold pit 210 is filled with the deposited film 215; (d) removing a portion of the deposited 215 film to form the probe 250; and (e) releasing the probe 250 from the mold substrate material 200.

The mold substrate material 200 can vary greatly depending on the pattern probe 205 being used to create the shape of the mold pit 210. Very soft materials like lead or photo-resist could be utilized as the mold substrate material 200 if the pattern probe 205 is made from a softer material like silicon or if the probe apex is delicate. Harder substrates more commonly utilized in the scanning probe microscopy field like Si, SiO2, Si3N4, Silicon on Insulator (SOI) and many others can be used as the mold substrate material 200 for all types of diamond pattern probes 205. In general, the pattern probe must be harder than the mold substrate material in order to create the pattern probe shape via the indent process in the mold substrate material.

Other variables like the pattern probe 205 shape, size, material, aspect ratio, indent depth and the deposition material 215 used to fill the mold pit 210 can all be manipulated to create the desired probe 250. For example, in cases of nanomachining and removal of debris with sub-millimeter dimensions, the deposited material which is often quantified by Young's modulus, is of vital importance. Nanomachining and the removal of debris with sub-millimeter dimensions, is described in detail in U.S. Pat. Pub. No. 2009/0071506 entitled “Debris Removal in High Aspect Structures”, which has been assigned to the assignee of the present invention and is hereby incorporated by reference. Diamond materials such as single crystalline diamond and ultra nano-crystalline diamond (UNCD) have Young's moduli of 800 GPa or more and are ideal for this type of application. However, there are a number of deposition materials 215 that have a Young's modulus great enough to be used in scanning probe microscopy, material hardness testing and even nanomachining applications which can be applied. Examples of deposition materials 215 that could be used in the present invention include Diamond (all forms), Ultra-nanocrystalline Diamond (UNCD), Boron nitride, Boron carbon nitride, Diamond like carbon (all forms), Tungsten carbide, Titanium diboride, Tantalum diboride, Zirconium diboride, Silicon carbide, Aluminum oxide (all forms including Sapphire and Ruby), Tungsten boride, Tungsten and Osmium. All of these materials have a Young's modulus greater than 400 GPa.

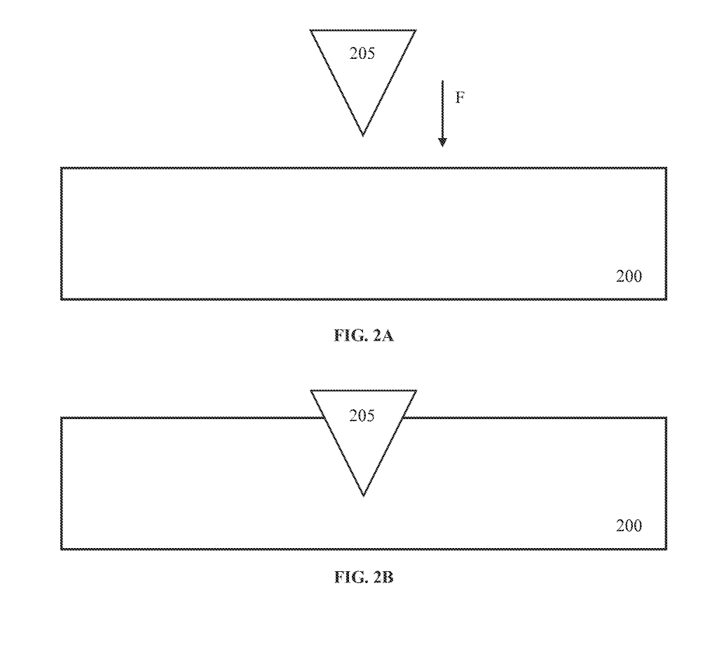

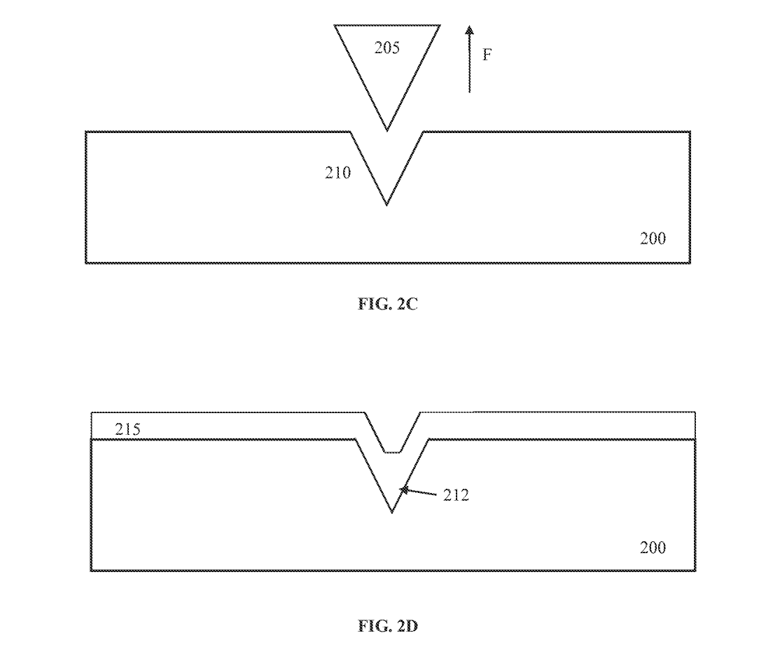

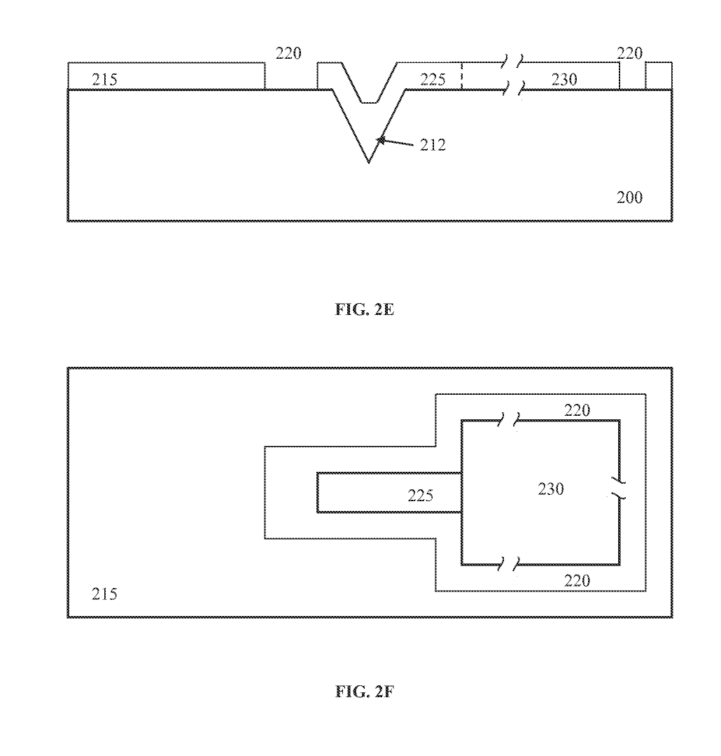

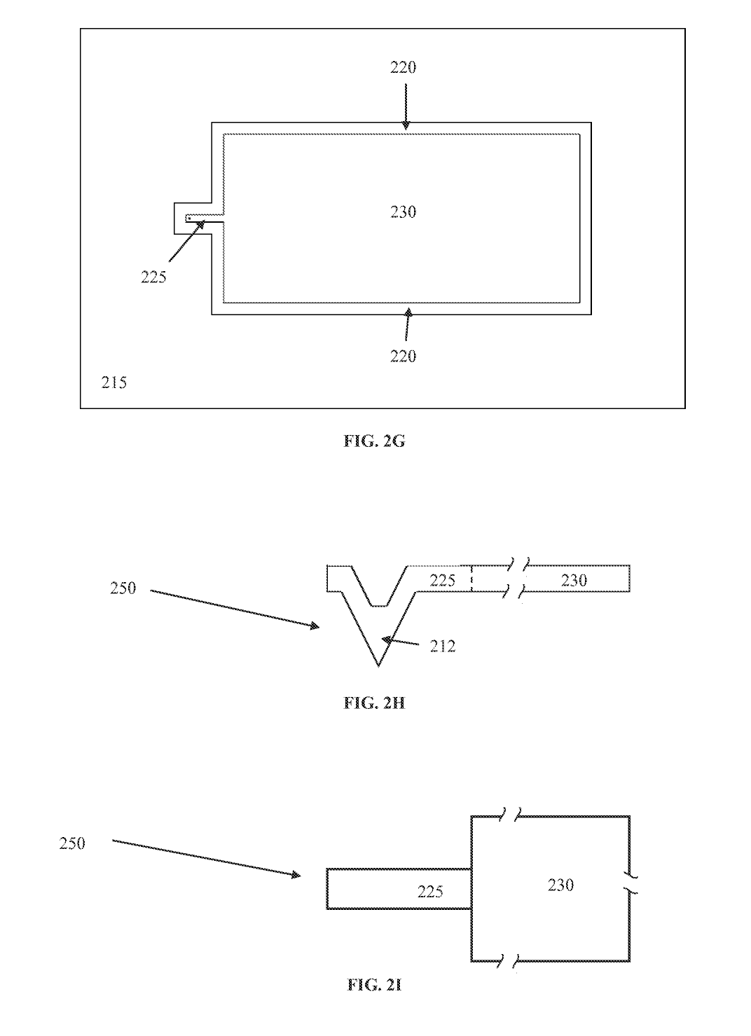

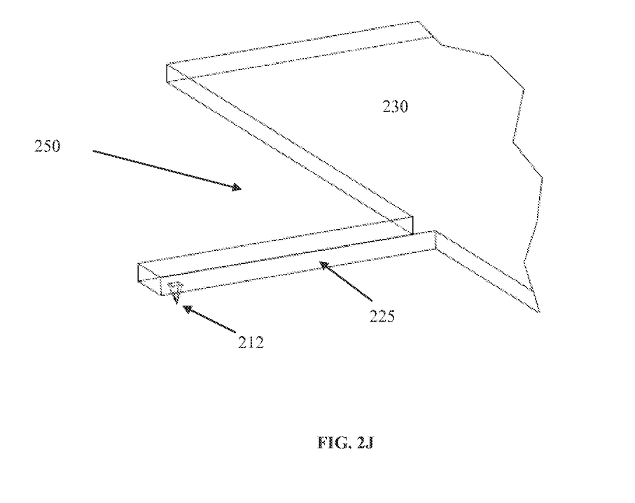

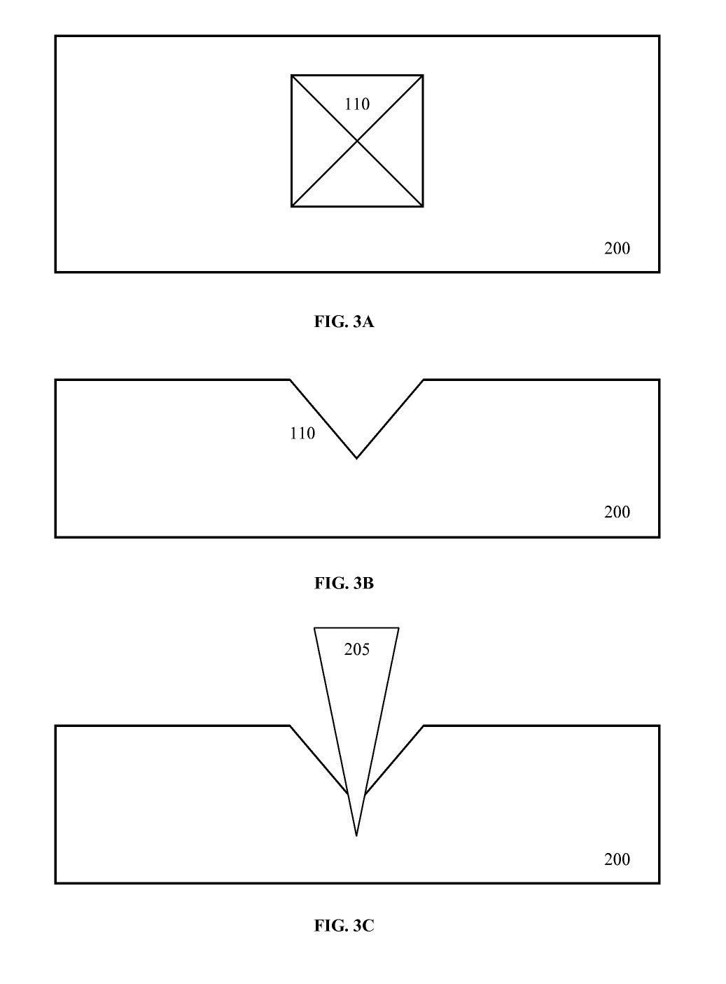

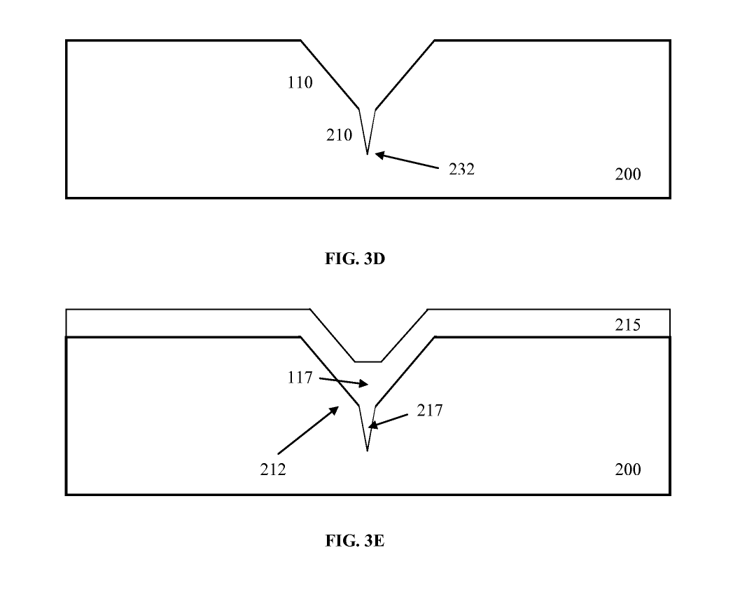

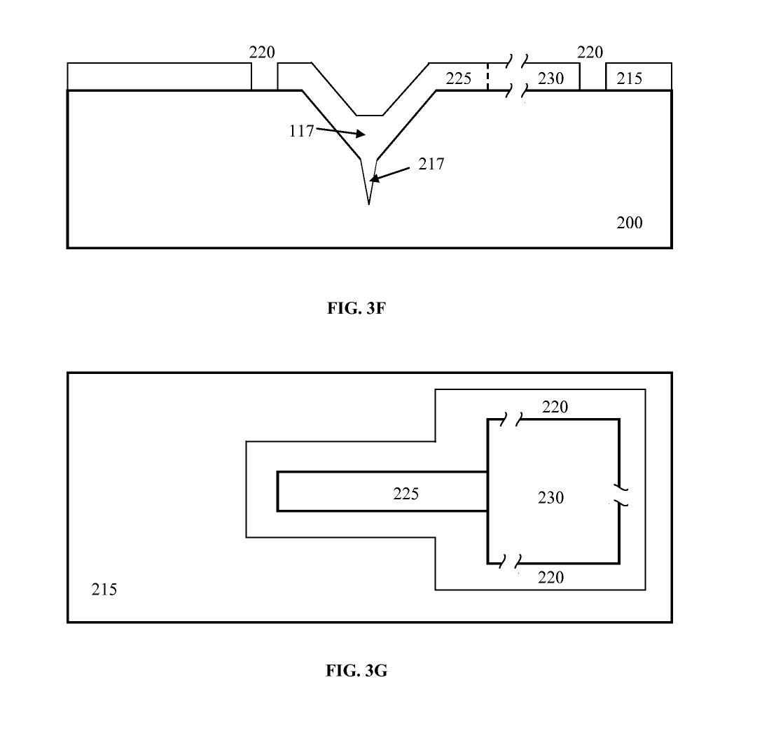

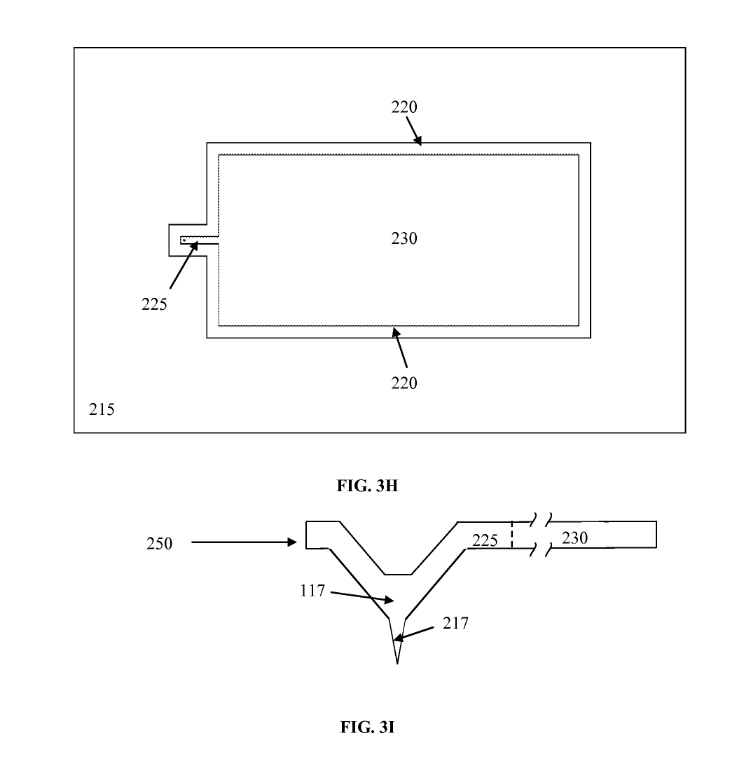

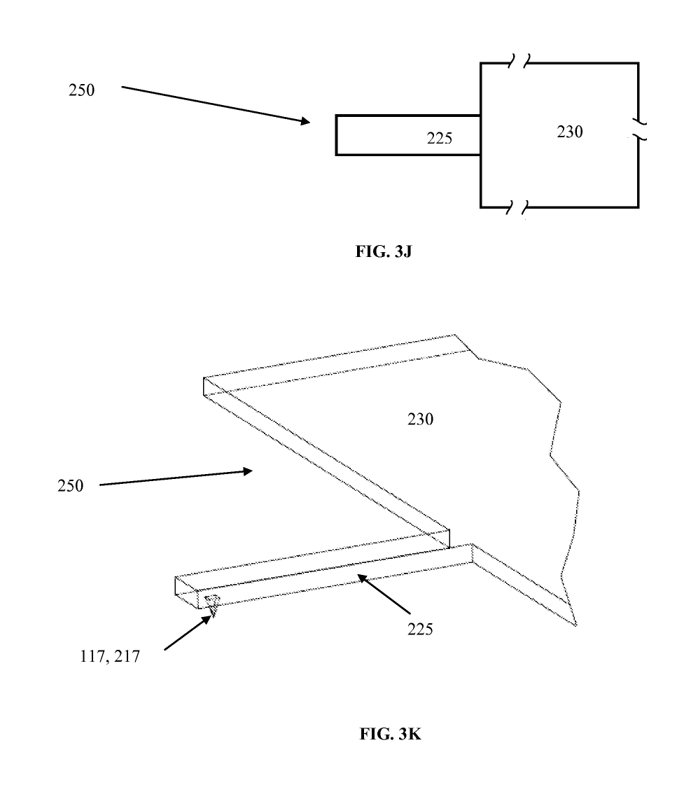

The SPM probe 250 has a planar body 230, a cantilever 225 extending from an edge of the body 230, and a tip 212, depending from an end of the cantilever 225, having a length and a width. Examples of the SPM probe 250 are shown in FIGS. 2(H)-2(J), FIGS. 3(I)-3(K). The size and dimensions of the SPM probe 250 are determined by the desired application for the probe 250. For example, the total area of the planar body 230 and cantilever 225 should not exceed 1 square centimeter for a scanning microscopy probe. The length of the cantilever 225 should be at least 1 micrometer but not exceed 1 millimeter. The length of the tip 212 ranges from 1 nanometer to 1 millimeter. All SPM probes 250 described and defined in the embodiments of the present invention described herein fall within these dimensions. The SPM probe 250 formed using the novel method provided by the present invention may have an aspect ratio that is greater than 0.71.

Referring now to FIGS. 2A-2J, a method of fabricating a SPM probe 250 according to one embodiment of the present invention is shown. A sharp diamond pattern probe 205 is forced into a mold substrate material 200 that is in this case a Si <100> wafer, FIG. 2A. Again, the mold substrate material 200 can be any material that is softer than the pattern probe 205 material and the pattern probe 205 material is not limited to diamond. The movement into the substrate surface by the pattern probe 205, FIG. 2B, will displace the silicon and form a mold pit 210 in the shape of the pattern probe 205. The pattern probe 205 is then retracted from the wafer surface, FIG. 2C, leaving a copy of the pattern probe 205, the mold pit 210, in the Si <100> surface 200. In some embodiments, the pattern probe 205 can be a three sided pyramid, a four sided pyramid, conical, cylindrical, a wedge, a curved cone or any combination of these shapes.

Any material that can be deposited as a film 215 via a vapor deposition process can be used to fill the mold pits 210 shown in FIG. 2D. In this embodiment, an ultra nano-crystalline diamond (UNCD) film 215 is deposited on the Si <100> wafer 200 creating a layer 215 of UNCD on the wafer surface that fills the mold pit 210 to form the tip 212. The UNCD layer 215 can then be coated with photo-resist, patterned by exposure to an energy source i.e., laser, lamp, electron beam, ion beam, through a masking process and developed to form voids in the photo-resist, not shown. These voids allow access to the UNCD film 215 so it can be etched to form the cantilever 225 and planar body 230 of the probe 250. Alignment of the masking for the UNCD cantilever 225 and planar body 230 with respect to the molded probe can be accomplished with standard semiconductor or MEMS/NEMS techniques. Once the deposited photo-resist on the UNCD film 215 has been patterned, the film 215 can be etched as shown in FIGS. 2E-2G. This etching creates voids 220 in the film 215 that define the planar body 230 of the probe 250, including the cantilever 225. At this point, the mold substrate material 200 can be removed via etching or released through other means from the UNCD film 215 as shown in FIGS. 2H-2J. In this embodiment, this can be done through a standard anisotropic wet etch process which will remove the Si<100> wafer material while not affecting the UNCD film 215, cantilever 225 and body 230 or the tip 212. The SPM probe 250 including planar body 230, cantilever 225 and tip 212 is monolithic in nature and made entirely from the deposited UNCD film 215. Once released, the SPM probe 250 is ready for use. Mounting the SPM probe 250 to a more substantial Si body is common but, not required.

In some instances, a long probe is needed and a greater indent depth will be required to achieve the specification. This in turn will require the displacement of more mold substrate material 200 and which will lead to great forces being experienced by the pattern probe 205. These forces if they become large enough could damage the pattern probe 205.

One embodiment of the present invention addresses this issue by etching an etch pit 150 in the mold substrate material 200 and then indenting the pattern probe 205 into the etch pit 150 to form a mold pit 210. Because the majority of the mold substrate material 200 is removed by the etch process, the force felt by the pattern probe 205 during indentation is much less and the likelihood for damage to the pattern probe 205 is diminished. FIGS. 3A-3K illustrate a method of fabricating a SPM probe 250 in which a mold substrate material 200 is initially etched to form an etch pit 150 before indenting occurs to form a mold pit 210.

In this embodiment the method of fabricating a SPM probe comprises: etching the mold substrate material to form an etch pit; positioning a pattern probe over a mold substrate; indenting the pattern probe into the etch pit to form the mold pit; depositing a film onto the mold substrate including the etch pit and the mold pit; removing a portion of the deposited film to form a probe, the probe including a body, a cantilever extending from an edge of the body, and a tip, depending from an end of the cantilever, having a length and a width; and releasing the probe from the mold substrate material.

As shown in FIGS. 3A and 3B, a square pyramidal anisotropic etch pit 150 is formed in the mold substrate material 200, which is a Si<100> wafer. In FIG. 3C, a sharp diamond pattern probe 205 is indented into the etch pit 150 on the Si<100> wafer 200. Again, the mold substrate 200 can be any material that is softer than the pattern probe 205 material. FIG. 3D shows the indentation left by the pattern probe 205 at the nadir of the etch pit 150. The indented portion of the etch pit 150 forms the mold pit 210, which has an apex 232 defined by the shape of the pattern probe 205, not the anisotropic etch process and thus has the shape, aspect ratio and tip length and width of the pattern probe 205. In this embodiment, the diamond pattern probe 205 can be a three sided pyramid, a four sided pyramid, conical, cylindrical a wedge, a curved cone or any combination of these shapes.

FIG. 3E shows the vapor deposition of a film 215 on the Si <100> wafer 200 that fills the etch pit 150 and the mold pit 210 including the mold pit apex 232, forming the tip 212. The tip 212 in this embodiment has an etch portion 117 and a mold portion 217. The etch portion 117 of the tip 212 is formed from the deposit film 215 filling the etch pit 150 and the mold portion 217 of the tip 212 is from the deposit film 215 filling the mold pit 210.

In this embodiment, the film deposited is UNCD, however, any material that can be vapor phase deposited can be used as the deposited film. The UNCD layer 215 can then be coated with photo-resist, patterned by exposure to an energy source (i.e., laser, lamp, electron beam, ion beam) through a masking process and developed to form voids 220 in the photo-resist. These voids 220 allow access to the UNCD film so it can be etched to form the cantilever 225 and body 230 of the probe 250. Alignment of the masking for the UNCD cantilever 225 and body 230 with respect to the deposited mold probe 250 can be accomplished with standard semiconductor or MEMS/NEMS techniques. Once the deposited photo-resist on the UNCD film 215 has been patterned, the film 215 can be etched as shown in FIGS. 3F-3H. This creates voids 220 in the film 215 that define the cantilever 225 and body 230 of the probe 250. At this point, the mold substrate material 200 can be removed via etching or released through other means from the UNCD film 215 as shown in FIGS. 3I-3K. In this embodiment, the Si <100> wafer 200 is etched away with a standard anisotropic wet etch process. This will remove the Si while not affecting the cantilever 225 and body 230, and the etch portion 117 and the mold portion 217 of the tip 212. Here again, the SPM probe 250 (tip 212 including the tip etch portion 117, tip mold portion 217, cantilever 225 and body 230) is monolithic in nature and made entirely from the UNCD film 215. Once released, the SPM probe 250 is ready for use. Mounting the single piece probe 250 to a more substantial Si body is common, but not required.

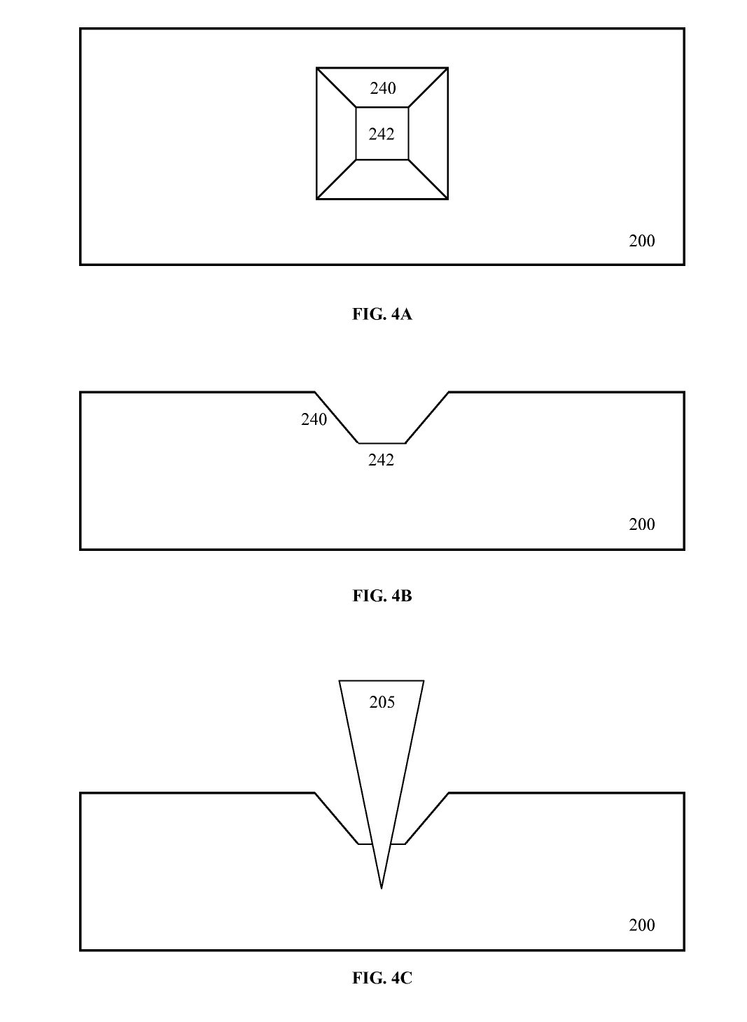

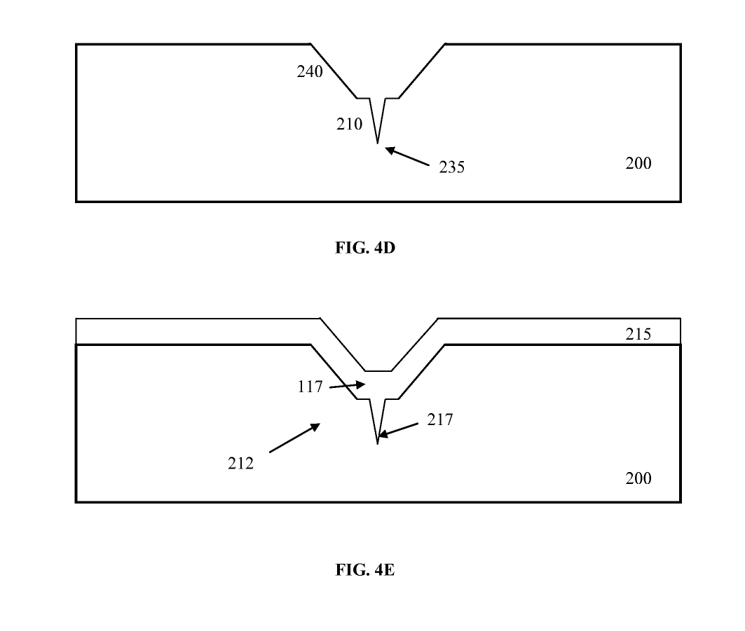

Referring now to FIGS. 4A-4E, another embodiment of the present invention allows for adjustment of length of the probe 250 by controlling the depth of the etch pit 150 etched in the mold substrate material 200. In the previous embodiment, the etching step is carried out to self-termination to create the etch pit 150. In another embodiment according to the present invention, the anisotropic silicon etch process is not carried out to self-termination but is instead halted at some intermediate etch depth. Halting the etching creates a square or rectangular pyramidal anisotropic etch pit 240 with a square or rectangular flat bottom 242 shown in FIGS. 4A-4B on a Si <100> wafer 200. In FIG. 4C, a sharp diamond pattern probe 205 is indented into the mold pit 240 on the Si <100> wafer 200. Again, the mold substrate 200 can be any material that is softer than the pattern probe 205 material.

FIG. 4D shows the indentation left by the pattern probe 205 on the flat bottom portion 242 of the square or rectangular etch pit 240. The indented portion of the square or rectangular etch pit 240 forms the mold pit 210, which has an apex 235 defined by the shape of the pattern probe 205, not the anisotropic etch process and thus has the shape, aspect ratio and tip length and width of the pattern probe 205. In this embodiment, the diamond pattern probe 205 can be a three sided pyramid, a four sided pyramid, conical, or wedge shaped. FIG. 4E shows the vapor deposition of a film 215 on the Si <100> wafer 200 that fills the square or rectangular etch pit 240 and the mold pit 210, including the mold apex 235, forming the tip 212. The tip 212 in this embodiment has an etch portion 117 and a mold portion 217. The etch portion 117 of the tip 212 is formed from the deposit film 215 filling the square or rectangular etch pit 240 and the mold portion 217 of the tip 212 is from the deposit film 215 filling the mold pit 210. The SPM probe 250 can then be formed by removing a portion of the deposited film 215 and releasing the probe 250 from the mold substrate material 200. The SPM probe 250 can be released from the mold substrate material 200 by using a wet etch process.

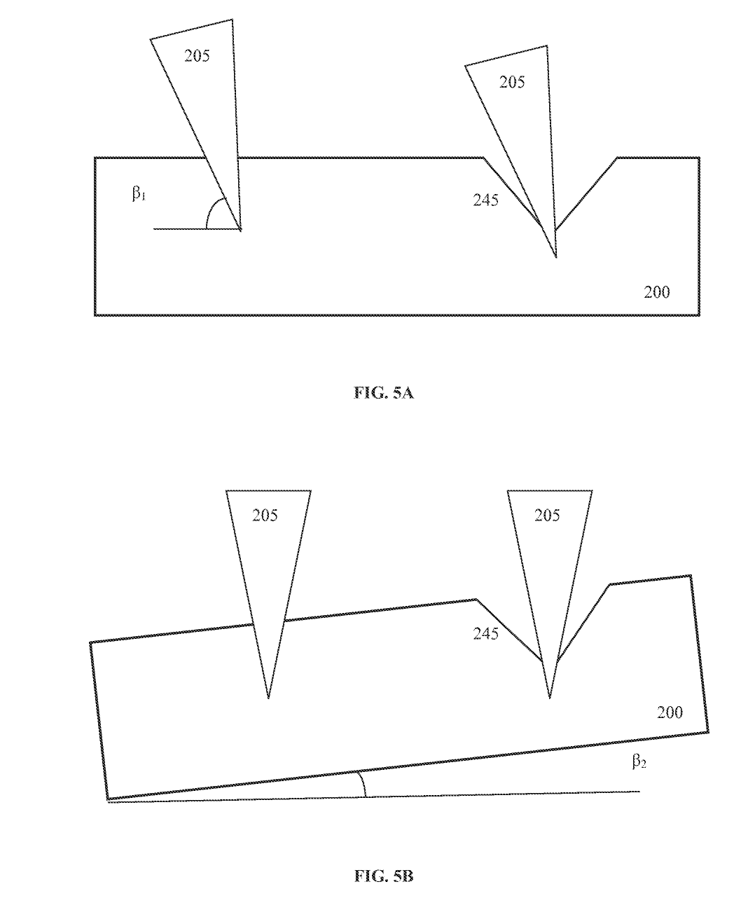

Referring now to FIG. 5A, in some embodiments, the step of positioning a pattern probe 205 having a desired aspect ratio over a mold substrate material 200 includes tilting the pattern probe 205 at an angle β with respect to the mold substrate material 200 prior to indenting. It is important to note that the entire probe may be tilted or the tip in the probe assembly may be tilted to form the angled mold pit. The tilt angle β may be a single angle or a compound angle. FIG. 5A shows a pattern probe 205 tilted at a single angle β with respect to the mold substrate material 200 and then indenting the pattern probe 205 into the mold substrate material 200. The tilt angle β whether it is a single angle or a compound angle must be greater than 0 and less than 180 degrees. This creates an angled mold pit 245 in the mold substrate surface 200 and allows for the fabrication of SPM probes 250 with non-equivalent sidewall or facet angles with respect to the planar body and/or cantilever 225 being created from the deposited film 215. It may also be the case where the entire probe is tilted at tilt angle β and the tip may be mounted to the probe assembly at a second tilt angle that is less than, equal to or greater than β such that a mold pit or an angle mold pit is formed in the mold substrate. Titling the pattern probe 205 can be done for all the embodiments of the present invention described above. For example, where the indent is occurring in a flat surface and where the indent is performed at the nadir of an etch mold pit 150 or where the etch mold pit 150 is not etched to self-termination and has a flat bottom.

Referring now to FIG. 5B, in some embodiments, the positioning step may include tilting the mold substrate material 200 at an angle β2 with respect to the pattern probe 205 prior to indenting to create an angled mold pit 245. The angle β2 may be single angle or compound angle. The tilt angle β2 whether it is a single angle or a compound angle must be greater than 0 and less than 180 degrees.

The pattern probe 205 may be tilted at a single angle or a compound angle as shown in FIG. 5B with respect to the mold substrate material 200 and then the pattern probe may be indented into the mold substrate material 200. In yet another embodiment, both the pattern probe 205 and the mold substrate 200 may be tilted at various single angles β, β2 or a compound angle to achieve a similar effect.

1. A method of fabricating a scanning probe microscopy probe, comprising:
positioning a pattern probe over a mold substrate;
indenting the pattern probe into the mold substrate material to form a mold pit;
depositing a film onto the mold substrate including the mold pit;
removing a portion of the deposited film to form a probe; and
releasing the probe from the mold substrate material,
wherein the probe is monolithic and includes a body, a cantilever extending in a first direction from an edge of the body, and a tip extending from an end of the cantilever at least partly in a second direction,
wherein a width of the body in a third direction is greater than a width of the cantilever in the third direction, and
wherein the first direction is perpendicular to the second direction, and the third direction is perpendicular to both the first direction and the second direction.

2. The method of fabricating a scanning probe microscopy probe of claim 1, wherein releasing the probe includes removing the probe substrate using a wet etch process.

3. The method of fabricating a scanning probe microscopy probe of claim 1, wherein the mold substrate material is a silicon wafer or a Si(100) wafer.

4. The method of fabricating a scanning probe microscopy probe of claim 1, wherein the pattern probe is a diamond probe, a single crystalline diamond probe or an Ultra Nano-Crystalline Diamond probe.

5. (canceled)

6. The method of fabricating a scanning probe microscopy probe of claim 1, wherein the depositing step uses vapor phase deposition and the deposited film is Ultra Nano-Crystalline Diamond.

7. The method of fabricating a scanning probe microscopy probe of claim 1, wherein the pattern probe is harder than the mold substrate material.

8. The method of fabricating a scanning probe microscopy probe of claim 1, wherein the positioning step further comprises tilting the pattern probe at an angle prior to indenting to create an angled mold pit.

9. The method of fabricating a scanning probe microscopy probe of claim 1 wherein the positioning step further comprises tilting the mold substrate material at an angle prior to indenting to create an angled mold pit.

10. (canceled)

11. A scanning probe microscopy probe formed by the method of claim 1, wherein the total area of the body and the cantilever does not exceed 1 square centimeter, the cantilever has a length that ranges from 1 micrometer to 1 millimeter and the length of the tip ranges from 1 nanometer to 1 millimeter.

12. The method of fabricating a scanning probe microscopy probe of claim 1, further comprising, before the positioning step, etching the mold substrate material to form an etch pit, and, wherein the indenting step includes indenting the pattern probe into the etch pit to form the mold pit.

13. The method of fabricating a scanning probe microscopy probe of claim 12, wherein the etch pit has a square pyramidal shape.

14. The method of fabricating a scanning probe microscopy probe of claim 12, wherein the etching is carried out to self-termination.

15. The method of fabricating a scanning probe microscopy probe of claim 12, wherein the etching is halted prior to self-termination to form a square or rectangular mold pit with a square or rectangular flat bottom.

16. (canceled)

17. A scanning probe microscopy probe formed by the method of claim 12, wherein the total area of the body and the cantilever does not exceed 1 square centimeter, the cantilever has a length that ranges from 1 micrometer to 1 millimeter, and the length of the tip ranges from 1 nanometer to 1 millimeter.

18. A scanning probe microscopy probe formed by the method of claim 1, wherein the pattern probe has a shape selected from the group consisting of a three-sided pyramid, a cone, a cylinder, a wedge, a curved cone, and combinations thereof.

19. A scanning probe microscopy probe formed by the method of claim 1, wherein
the body includes a first body surface and second body surface, the first body surface being opposite the second body surface,
the cantilever includes a first cantilever surface and a second cantilever surface, the first cantilever surface being opposite the second cantilever surface,
the first body surface is substantially coplanar with the first cantilever surface, and
the second body surface is substantially coplanar with the second cantilever surface.

20. The scanning probe microscopy probe of claim 19, wherein a thickness of the cantilever in the second direction is substantially equal to a thickness of the body in the second direction.
